(19) United States
(12) Patent Application Publication
(10) Pub. No.: US 2006/0261111 A1
(43) Pub. Date: Nov. 23, 2006

(54) Modular cargo carrier assembly

(76) Inventors: Richard W. McCoy, Granger, IN (US); Jason R. Moldthan, Greer, SC (US); George O. Snook, South Bend, IN (US)

Correspondence Address: McDonald Hopkins Co, 600 Superior Avenue East, Suite 2100, Cleveland, OH, 44114, US

(21) Appl. No.: 10/533,672

(22) PCT Filed: Nov. 4, 2003
(86) PCT No.: PCT/US03/35138

§ 371 Date: Jul. 17, 2006

Related U.S. Application Data
(60) Provisional application No. 60/423,628, filed on Nov. 4, 2002.

(51) Int. Cl. B60R 7/00; B60R 9/00; B60R 11/00

(52) U.S. Cl. 224/499; 224/519; 224/526; 224/42.38

(57) ABSTRACT

A cargo carrier assembly includes a platform adapted to nestingly support a cargo container. The cargo container includes projections extending outwardly for matingly engaging aligned slots in the platform. The cargo container bottom periphery defines an exterior dimension that is less than the exterior dimension defined by the cargo container side wall periphery, whereby the container side wall exterior surface and the platform side wall exterior surface are substantially coplanar when the cargo container is nested on the platform.

This application claims the benefit of U.S. Provisional Patent Application Ser. No. 60/423,628, filed Nov. 4, 2002.

### TECHNICAL FIELD

The present invention relates generally to vehicle-mounted cargo carriers and, more particularly, to a novel modular cargo carrier assembly for expanding the cargo carrying capacity and versatility of a vehicle.

### BACKGROUND OF THE INVENTION

Regardless of the type of vehicle, it will likely be used to carry cargo of varied types. Even passenger vehicles must be able to transport substantial cargo, such as clothing and recreational equipment for family road trips, work-related equipment, household or garden items, foods and beverages, and the like. Particularly in the case of a passenger vehicle, the cargo carrying requirement for many of today's vehicles often exceeds the vehicle's actual space capacity. On other occasions, the cargo may simply be of a nature unsuited for carrying inside the trunk or passenger compartment of the vehicle. It is therefore known to provide attachments or accessories allowing expansion of the cargo carrying space of a vehicle.

Accessory carriers comprising a cargo container mounted to the rear of a vehicle are known. It is also known to provide a cargo tray or platform which may be secured to the rear of a vehicle. Such a tray or platform may carry a variety of cargo, including open or closed cargo containers or boxes. However, a conventional cargo platform/container combination requires the user to secure the two elements together, such as by using rope, bungee cords, or the like, prior to transporting the desired cargo. The need to lash the cargo container to the platform thus reduces the convenience of the accessory to the user.

To address the above-described need in the art, the present invention relates to a novel modular cargo carrier assembly for expanding the cargo carrying capacity of a vehicle. Specifically, the present invention provides a modular assembly comprising a platform and a cargo container assembly, which when mounted to a vehicle significantly increase the cargo carrying capacity of same. The features of the present invention eliminate the need for additional means for securing the cargo container to the platform, and desirably when the modular features are secured to the rear of a vehicle provide an attractive, unitary appearance to the assembled unit. A variety of additional accessories may also be secured to the platform of the present invention, thereby providing enhanced versatility in hauling a range of useful vehicle and personal accessories in a more effective and convenient manner.

### SUMMARY OF THE INVENTION

In accordance with the purposes of the present invention as described herein, a modular cargo carrier assembly is provided. The assembly may be beneficially utilized to secure a cargo container, as well as any of a number of additional useful accessories, to an accessory receiver assembly carried on a motor vehicle.

The assembly of the present invention includes a platform which may be secured to an accessory mounting bracket as will be described below using conventional fasteners such as cooperating nuts and bolts. Advantageously, the platform itself is adapted for use as an open cargo carrier, and may carry a variety of cargo or other accessories in addition to the cargo container of the present invention. The assembly further includes a cargo container adapted to be supported by and nest with the platform to complete a modular assembly.

In one aspect, the present invention provides a modular cargo carrier assembly, comprising a cargo container and a platform. The cargo container may comprise a bottom and a container side wall extending upwardly from a periphery of the bottom wherein the container bottom and container side wall define an interior compartment. The platform may comprise a floor and a platform side wall extending upwardly from a periphery of the floor. In combination, the platform floor and side wall define a receiver portion adapted to nestingly support the cargo container thereon.

The cargo container bottom periphery may define an exterior dimension that is less than the exterior dimension defined by the cargo container side wall periphery, whereby the container side wall exterior surface and the platform side wall exterior surface are substantially coplanar when the platform is nestingly supporting the cargo container. It will be appreciated that, when the platform and cargo container are assembled, an attractive, smooth-sided, unitary appearance is provided. At least one latch or lock for securing the container to the platform side wall may be provided.

Still further, typically the cargo container includes at least one projection extending outwardly from the container bottom periphery. In this embodiment, the platform will include at least one slot aligned with and adapted to matingly engage the cargo container projection when the platform is nestingly supporting the cargo container. The slot may extend only partially into the platform to form a recess. In a preferred embodiment, the platform slot defines an opening extending substantially through the platform side wall. It will be appreciated that this feature conveniently provides a tie-down for use when the platform is utilized as a stand-alone cargo carrier.

The platform floor further may include a plurality of aligned mounting apertures allowing the securing of the platform to a support accessory as will be described in greater detail below. Still further, the platform and cargo container may include at least one aligned drainage aperture for selectively permitting fluid communication between the cargo container interior compartment and an exterior of the container. This feature allows drainage of liquid, such as for example water from melting ice, from the interior of the cargo container without requiring removal of the container from the platform.

The cargo container may serve as an open-topped container, or may include a cover for attaching to an upper end of the container side wall. Typically, the cover will be hingedly attached to the container side wall. The cargo container will also include a latching or locking mechanism for securing the lid in a closed position. To increase the convenience and utility of the cargo container, the cargo container side wall may include at least one carrying handle. The cargo container side wall or bottom may further include at least one wheel. Typically, paired wheels will be provided for ease of use. These features significantly increase the convenience to the user, as the handles allow the container to be more easily removed from the platform, and heavier cargo carried in the container will be more easily transported in a wheeled container. The platform floor or side wall may include at least one wheel receiving slot, which is aligned with the wheel when the platform is nestingly supporting the cargo container. Similarly, the handle may be recessed into the cargo container side wall in any conventional fashion, such as by a pivoting connection for the handle and a recess provided in the cargo container side wall adapted to accept the handle. Inadvertent dislodgement of the handle from the recess may be prevented by any of a number of mechanisms, such as a strap or by configuring the recess to releasably retain the handle in a tight friction fit. In this way, the modular construction of the assembled unit is preserved.

In another aspect, a modular cargo carrier assembly is provided comprising a cargo container and a platform as described above, and an accessory support assembly for carrying the cargo carrier assembly and securing the cargo carrier assembly to an accessory receiver assembly secured to a vehicle. The features of the platform and cargo container may be as described above.

As noted above, the platform floor will typically include a plurality of aligned mounting apertures. The accessory support assembly may be any conventional support assembly known in the art, such as a suitable frame having a center-mounted drawbar for securing to a conventional hitch receiver. As will be described in greater detail below, a preferred accessory support assembly is one of the Dual Port System supports manufactured by Cequent Towing Products, Inc., which provides an accessory support assembly comprising paired mounting posts for securing to an accessory receiver assembly on a vehicle, and accessory mounting brackets having mounting apertures on an upper surface thereof. Accordingly, the platform may easily be mounted to the accessory support assembly, such as by use of cooperating nuts and bolts.

In yet another aspect, the present invention provides a modular cargo carrier assembly comprising a cargo container and a platform as described above in combination with an accessory support assembly for carrying the cargo carrier assembly and securing the cargo carrier assembly to an accessory receiver assembly secured to a vehicle, wherein the accessory support assembly comprises a mounting post and an accessory mounting bracket pivotally secured to the mounting post so that the bracket is selectively displaceable between a first position and a second position. It will be appreciated that this feature conveniently allows the platform to be displaced from a first, substantially horizontal cargo-carrying position to a second, storage position when no cargo is to be carried, thereby reducing the size of the vehicle “footprint” without necessitating removal of the cargo carrier assembly.

### BRIEF DESCRIPTION OF THE DRAWING

The accompanying drawing incorporated in and forming a part of the specification, illustrates several aspects of the present invention and together with the description serves to explain certain principles of the invention. In the drawings:

FIG. 1 is an exploded rear perspective view of the modular cargo carrier assembly of the present invention, showing a cargo container, a platform, paired support arm assemblies, and a hitch receiver assembly for receiving the support arm assemblies;

FIG. 2 is a rear perspective view of the cargo carrier assembly of the present invention;

FIG. 3 is an exploded rear elevational view of the cargo carrier assembly of the present invention, showing the platform slots and cooperating projection on the side wall of the cargo container in isolation;

FIG. 4 is a front elevational view of the cargo carrier assembly, showing a latching mechanism for securing the cargo container to the platform;

FIG. 5 illustrates the platform of the present invention wherein the support arm assembly is pivoted to carry the platform in a vertical orientation; and

FIG. 6 is a rear perspective view of a cargo container including wheels and handles thereon.

Reference will now be made in detail to the present preferred embodiment of the invention, an example of which is illustrated in the accompanying drawings.

### DETAILED DESCRIPTION OF THE INVENTION

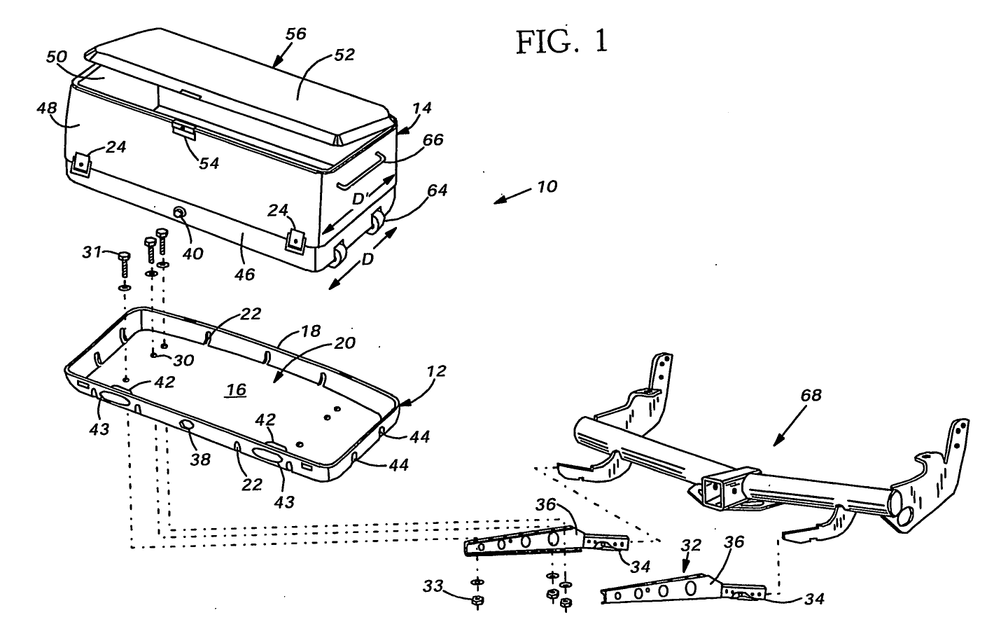

Referring now to FIG. 1, the assembly 10 of the present invention includes a platform 12 and a cargo container 14. The platform 12 includes a floor 16 and a side wall 18 that define a receiver portion generally identified by reference numeral 20. Advantageously, the platform 12 of the invention may be used to support a variety of accessories as will be discussed in greater detail below, or may be used alone to carry cargo secured thereto. The platform side wall 18 includes spaced slots 22 therethrough, which as will be described below are used to enhance the secure fit between the platform 12 and cargo container 14. The slots 22 may also be used as tie-downs when the platform 12 is used as a stand-alone carrier.

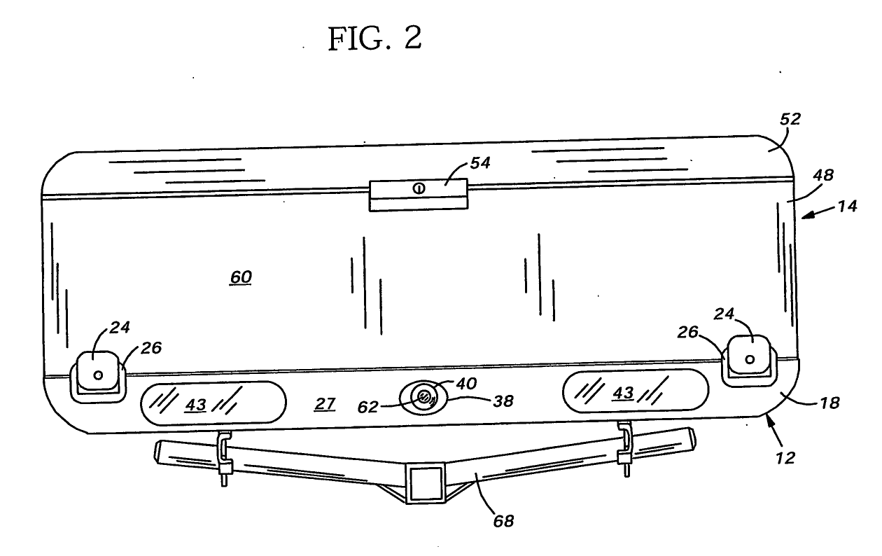

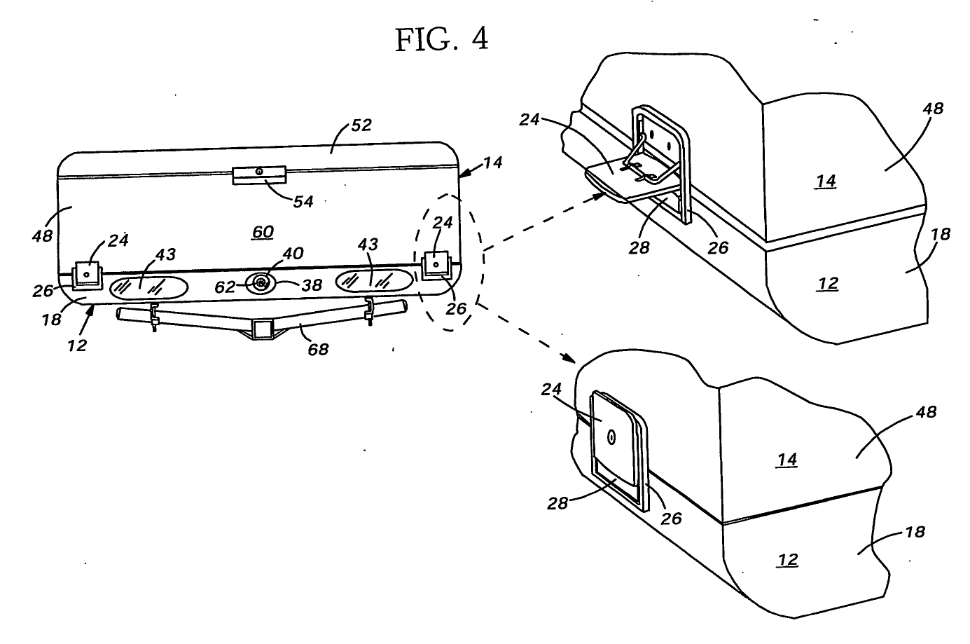

The platform 12 further includes at least one latch or lock 24 for securing the cargo container 14 in place. Any suitable lock or latch 24 mechanism may be adapted to the present invention. In the embodiment depicted in FIG. 2, the front portion 27 of the platform side wall 18 includes at least one lock or latch 24 of the type depicted in FIG. 4, having a catch 26 adapted to capture an aligned shoulder or lip 28 on cargo container 14, and may further include a locking mechanism (not shown) to prevent inadvertent dislodgement of catch 26 from lip 28. Of course, other suitable locking/latching mechanisms of a type known in the art may be used, such as snap-locks, catch and padlock hasp combinations, padlock and hasp combinations, or the like (not shown).

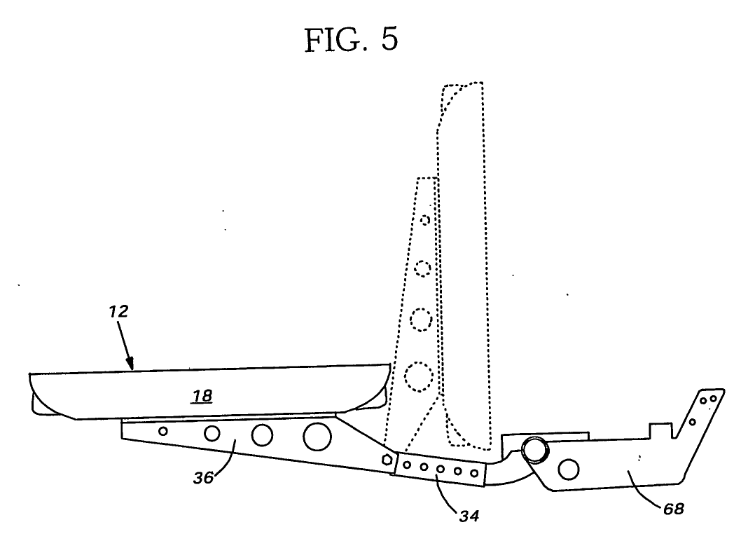

Spaced mounting apertures 30 are provided through the floor 16 of the platform 12 to allow securing platform 12 to a supporting bracket using conventional fasteners such as nuts and bolts 31, 33. The modular platform 12 of the present invention may be secured to a vehicle using conventional means such as a supporting frame having a draw bar adapted to be received in a conventional hitch box of a hitch receiver assembly (not shown). More typically, a two-point support such as the Dual Port System equipment manufactured by Cequent Towing Products, Inc. will be used. The platform 12 may be secured to the vehicle using an accessory support assembly 32 as described in copending U.S. patent application Ser. No. 10/283,999 and PCT patent application no. PCT/US02/34739, both filed on Oct. 30, 2002 and entitled “Universal Accessory Support Assembly” (incorporated herein in their entirety by reference). As described therein and depicted in FIGS. 1 and 5 herein, the accessory support assembly 32 includes a mounting post 34 and an accessory mounting bracket 36 that is pivotally secured to the mounting post 34 so that the accessory mounting bracket 36 (and any cargo carrier or other accessory attached thereto) may be selectively displaced from a substantially vertical plane to a substantially horizontal plane projecting outwardly from the vehicle (see FIG. 5).

It will be appreciated that the mounting apertures 30 will also allow a variety of additional accessories (not shown) to be fastened to the platform 12 or to both the platform 12 and the accessory mounting bracket 36 using fasteners such as cooperating nuts and bolts (not shown) of sufficient length. For example, a wheel-mounting channel of a bicycle rack of known manufacture (not shown) may be directly secured to the platform. Alternatively, in the event that the accessory is of greater length or width than the platform 12, risers, spacers, or secondary racks (not shown) may be attached to the platform floor to provide the desired amount of clearance between the accessory and the platform side wall 18. It will also be appreciated that the mounting apertures 30 may be recessed into the platform floor 16, thereby providing a space below the floor 16 that receives the head of the fasteners to prevent damage to cargo placed on the platform 12 that might otherwise be caused by the fasteners.

The platform side wall 18 may further include a platform drainage aperture 38 allowing drainage of liquid from an aligned cargo container drainage aperture 40 in the cargo container 14 (see FIG. 1), without necessitating separation or removal of platform 12 and cargo container 14. The platform 12 may also include at least one recess 42 for receiving a light fixture, which beneficially allows, e.g., taillights and/or turn signals 43 to be mounted to the platform 12 without interfering with the ability of the user to attach the cargo container 14. Still further, the platform may include additional recesses or cutouts for receiving and concealing features of the cargo container, such as for example a wheel-receiving slot 44.

The cargo container 14 of the present invention is designed to be nested with the platform 12. The cargo container 14 includes a bottom 46 and a side wall 48 defining an interior compartment 50, and may include a cover 52. The cover 52 may be hingedly attached to an upper end of the cargo container side wall 48, and may further include a lock or latch mechanism 54 for securing cover 52 in the closed position. The periphery of the cargo container bottom 46 defines an exterior dimension D that is less than an exterior dimension D′ defined by the periphery of the cargo container side wall 48, such that the container side wall 48 exterior surface and the platform side wall 18 exterior surface are substantially coplanar when the platform 12 is nestingly supporting the cargo container 14 (see FIG. 2). It will be appreciated that, when the platform 12 and cargo container 14 are assembled, an attractive, smooth-sided, unitary appearance is provided as shown in FIG. 2.

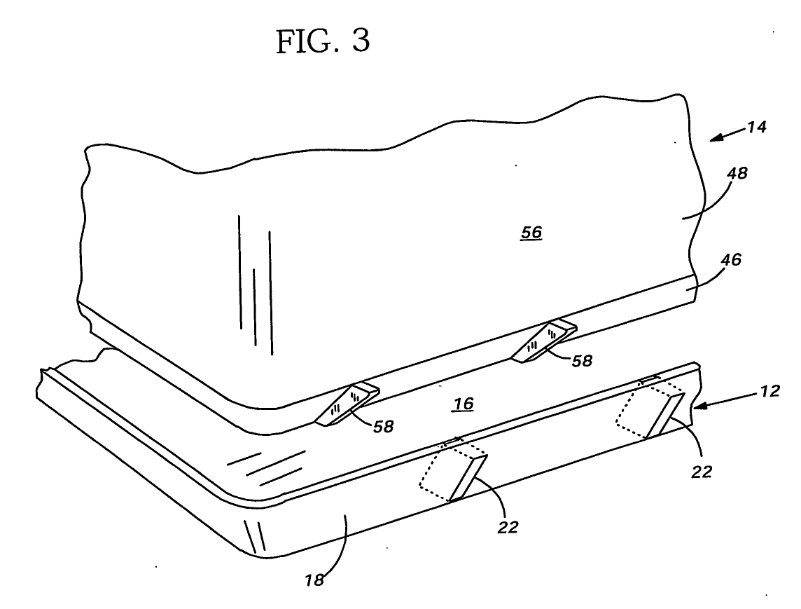

The rear portion 56 of the cargo container 14 may include at least one projection 58 adapted to be matingly received in the platform slots 22 as shown in FIG. 3. As described above, the front portion 60 of the cargo container side wall 48 may include at least one lip or shoulder 28 as shown in FIG. 4 which, when platform 12 and cargo container 14 are properly nested, is captured by catch 26 on platform 12 to secure the cargo container 14 in place. Of course, it will be appreciated that a plurality of lips 28 may be included in cargo container side wall 48, aligned with an equal number of catches 22 on platform 12.

A cargo container drain aperture 40 may be provided near the cargo container bottom 46, located such that when platform 12 and cargo container 14 are nested, platform drain aperture 38 and cargo container drain aperture 40 are aligned to allow drainage of fluid from cargo container interior compartment 50. A cargo container drain aperture plug 62 may be provided which removably seals cargo container drain aperture 40; and is accessible from an exterior of the cargo carrier assembly 10 through platform drain aperture 38. Thus, it will be appreciated that drainage of liquid from the interior of the cargo container 14 may be accomplished without necessitating separation of the cargo container 14 from the platform 12.

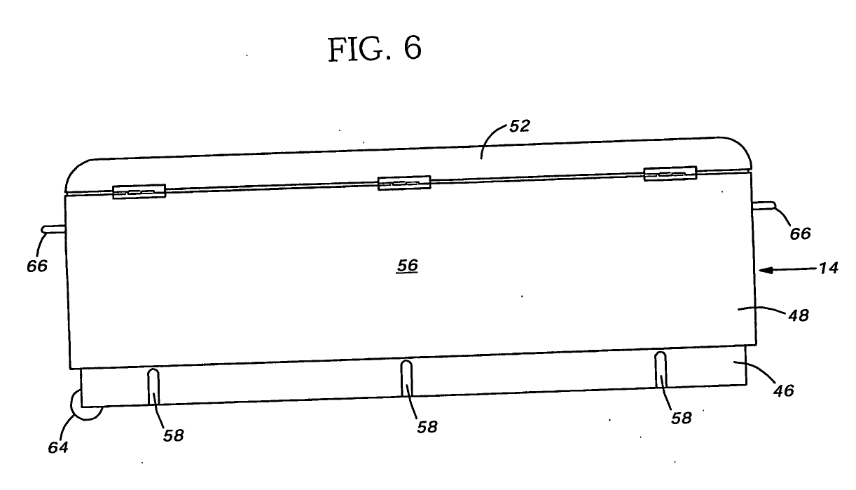

Additional features may be included on cargo container 14. For example, as shown in FIG. 6, wheels 64 and handles 66 may be provided on the cargo container 14 to enhance the ease of transporting cargo container 14 when it is separated from the platform 12. As described above, wheel receiving slots 44 may be provided in the platform 12 to receive the wheels 64 when the cargo container 14 is nested with the platform 12. Further, the handles 66 may be fixedly mounted to cargo container side wall 48 as shown in FIG. 6, or may be recessed, articulated or retractable as is known in the art for storage when the cargo container 14 is mounted to the platform 12 for transport by a vehicle.

The use of the modular cargo carrier assembly 10 will now be described. In operation, paired universal support bracket assemblies as described in copending U.S. patent application Ser. No. 10/283,999 and PCT patent application no. PCT/US02/34739, both filed on Oct. 30, 2002 and entitled “Universal Accessory Support Assembly” (incorporated herein in their entirety by reference) are mounted to a hitch receiver assembly 68 secured to a vehicle (not shown). As shown in FIGS. 1 and 2, the platform 12 may be secured to the accessory mounting brackets 36 using suitable fasteners passed through mounting apertures 30. Projections 58 extending from the cargo container side wall 48 are then matingly inserted through platform slots 22 as the cargo container 14 is lowered to nest with platform 12. Capturing lips 28 on the cargo container side wall 48 with catches 26 on the platform side wall 18 completes the secure connection.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiment do not and are not intended to limit the ordinary meaning of the claims and their fair and broad interpretation in any way.

1. A modular cargo carrier assembly, comprising:
a cargo container connectable to a vehicle, said cargo container comprising a bottom and a container side wall extending upwardly from a periphery of said bottom, said bottom and container side wall defining an interior compartment;
a platform comprising a floor and a platform side wall extending upwardly from a periphery of said floor, said floor and platform side wall defining a receiver portion adapted to nestingly support the cargo container thereon; and
at least one latch or lock attached to said sidewall of said cargo container to secure the container to the platform side wall.

2. The assembly of claim 1, wherein the cargo container bottom periphery defines an exterior dimension that is less than the exterior dimension defined by the cargo container side wall periphery, whereby the container side wall exterior surface and the platform side wall exterior surface are substantially coplanar when the platform is nestingly supporting the cargo container.

3. (canceled)

4. The assembly of claim 1, wherein said cargo container includes at least one projection extending outwardly from the container bottom periphery.

5. The assembly of claim 4, wherein said platform includes at least one slot aligned with and adapted to matingly engage the cargo container projection when the platform is nestingly supporting the cargo container.

6. The assembly of claim 5, wherein said slot defines an opening extending substantially through the platform side wall.

7. (canceled)

8. The assembly of claim 1, wherein said platform and cargo container further include at least one aligned drainage aperture for selectively permitting fluid communication between the cargo container interior compartment and an exterior of the container.

9. The assembly of claim 1, wherein said cargo container further includes a cover attached to an upper end of the container side wall.

10-11. (canceled)

12. The assembly of claim 9, wherein said cargo container side wall or bottom includes at least one wheel.

13. The assembly of claim 12, wherein said platform floor or side wall includes at least one wheel receiving slot aligned with said wheel when the platform is nestingly supporting the cargo container.

14. A modular cargo carrier assembly, comprising:
a cargo container comprising a bottom and a container side wall extending upwardly from a periphery of said bottom and at least one projection extending outwardly from said container bottom periphery, said bottom and container side wall defining an interior compartment; and
a platform comprising at least one slot aligned with and adapted to matingly engage said projection, a floor, and a platform side wall extending upwardly from a periphery of said floor, said floor and platform side wall defining a receiver portion adapted to nestingly support the cargo container thereon and wherein said projection of said cargo container matingly engages the slot of said platform when the platform is nestingly supporting the cargo container.

15. (canceled)

16. The assembly of claim 14, wherein said cargo container side wall includes at least one latch or lock for securing the container to the platform side wall.

17-18. (canceled)

19. The assembly of claim 16, wherein said slot defines an opening extending substantially through the platform side wall.

20. (canceled)

21. The assembly of claim 31, wherein the accessory support assembly comprises a mounting post and an accessory mounting bracket having mounting apertures aligned with said platform mounting apertures.

22. The assembly of claim 14, wherein said platform and cargo container further include at least one aligned drainage aperture for selective drainage from the cargo container interior compartment to the exterior of the container.

23-25. (canceled)

26. The assembly of claim 22, wherein said cargo container side wall or bottom includes at least one wheel.

27. The assembly of claim 26, wherein said platform floor or side wall includes at least one wheel receiving slot aligned with said wheel when the platform is nestingly supporting the cargo container.

28. A modular cargo carrier assembly comprising:
a cargo container comprising a bottom and a container side wall extending upwardly from a periphery of said bottom, said bottom and container side wall defining an interior compartment;
a platform comprising a floor and a platform side wall extending upwardly from a periphery of said floor, said floor and platform side wall defining a receiver portion adapted to nestingly support the cargo container thereon;
at least one drainage aperture located on said platform; and
at least one drainage aperture located on said cargo container aligned with said drainage aperture of said platform for selective drainage from the cargo container interior compartment to the exterior of the cargo container.

29. The assembly of claim 28, further comprising an accessory support assembly for carrying the cargo carrier assembly and securing the cargo carrier assembly to an accessory receiver assembly secured to a vehicle.

30. The assembly of claim 29, wherein the accessory support assembly comprises a mounting post and an accessory mounting bracket pivotally secured to said mounting post so that said bracket is selectively displaceable between a first position and a second position.

31. The assembly of claim 14, further comprising an accessory support assembly for carrying the cargo carrier assembly and securing the cargo carrier assembly to an accessory receiver assembly secured to a vehicle.
